(19) United States
(12) Patent Application Publication
(10) Pub. No.: US 2006/0189338 A1
(43) Pub. Date: Aug. 24, 2006

(54) Updating a database of terminal capabilities for use in service provision to a wireless terminal

(76) Inventors: Musa Raoul Unmehopa, Amersfoort (NL); Kumar Venkata Visveswara Vemuri, Naperville, IL (US)

Correspondence Address: LUCENT TECHNOLOGIES INC.;DOCKET ADMINISTRATOR, 101 CRAWFORDS CORNER ROAD - ROOM 3J-219, HOLMDEL, NJ, 07733, US

(21) Appl. No.: 11/061,835

(22) Filed: Feb. 18, 2005

(51) Int. Cl. H04B 7/00

(52) U.S. Cl. 455/518

(57) ABSTRACT

A method is provided of providing a telecommunications service to a wireless telecommunications terminal. This is by first receiving an indication that capability of the terminal has changed. A record in a database is then updated as to the change. The database is inspected so as to provide a telecommunications service adapted according to the updated record of the terminal's capability.

### FIELD OF THE INVENTION

The present invention relates to wireless telecommunications.

### DESCRIPTION OF THE RELATED ART

In some known wireless telecommunications systems, such as those operating Wireless Application Protocol (“WAP”), there is the idea of considering terminal capabilities. Information of these capabilities can be registered within a Terminal Capabilities database for ease of access. The Terminal Capabilities database keeps records of characteristics of terminals, such as screen size and memory available. This information is stored at the time that the terminal is configured and handed out to a user ready for use in a wireless telecommunications network. This can be at the start of a user subscription to a network of a service provider, or when the terminal is replaced as part of an on-going contract between a user and service provider. This information is used in software controlled services, often referred to in this field as applications. For example the screen size information is used by applications such that high-resolution images are not transmitted to user terminals having screens that are small and of a low resolution.

In the field of wireless telecommunications, terminals, such as mobile phones, are evolving. For example there are now terminals, such as J2ME (Java 2 Micro Edition) terminals and BREW (Binary Runtime for Wireless) terminals, that support execution of programs within the terminal. Other known terminals are being built which have operating systems (“OS”) that were previously only used in computers proper. Whilst still somewhat simplified compared to comparable systems on computers, what can be done with such operating systems on wireless terminals has increased.

J2ME terminals, BREW terminals, and terminals with operating systems can be upgraded or altered from time to time with new software, for example transmitted by radio. Accordingly, such terminals can be considered “soft terminals” in that their capabilities can be changed by such software downloads. These downloads allow an evolving range of applications to be supported.

### SUMMARY OF THE INVENTION

The inventors realised that when the capabilities of a terminal are enhanced, be it through software download or by connecting hardware components, the information in the terminal capabilities database can be, and should be, updated.

An example of the present invention is a method of providing a telecommunications service to a wireless telecommunications terminal. This is by receiving an indication that capability of the terminal has changed. A record in a database is then updated as to the change. The database is inspected so as to provide a telecommunications service that is adapted using the updated record to the terminal's changed capability.

Another example is a method of receiving a telecommunications service. This includes the step of replacing or upgrading a component of a wireless telecommunications terminal so as to change the capability of the terminal. A notification of the change in capability of the terminal is sent. A telecommunications service adapted to the changed capability is received.

The inventors realised that manufacturers of mobile terminals could develop plug-in hardware components, other than just headset attachments as available today, for example screens, memories and keypads. The terminal could run an operating system with appropriate software such that both software and hardware components can be upgraded “on the fly”—e.g., during the lifetime of use by the user.

### BRIEF DESCRIPTION OF THE DRAWINGS

Embodiments of the present invention will now be described by way of example and with reference to the drawings, in which:

FIG. 1 is a diagram illustrating known use of a terminal capabilities database;

FIG. 2 is a diagram illustrating a first embodiment;

FIG. 3 is a diagram illustrating use of the system shown in FIG. 2 to process and send an image to the terminal;

FIG. 4 is a diagram illustrating a second embodiment; and

FIG. 5 is a diagram illustrating a third embodiment.

The drawings are not to scale but are schematic representations.

### DETAILED DESCRIPTION

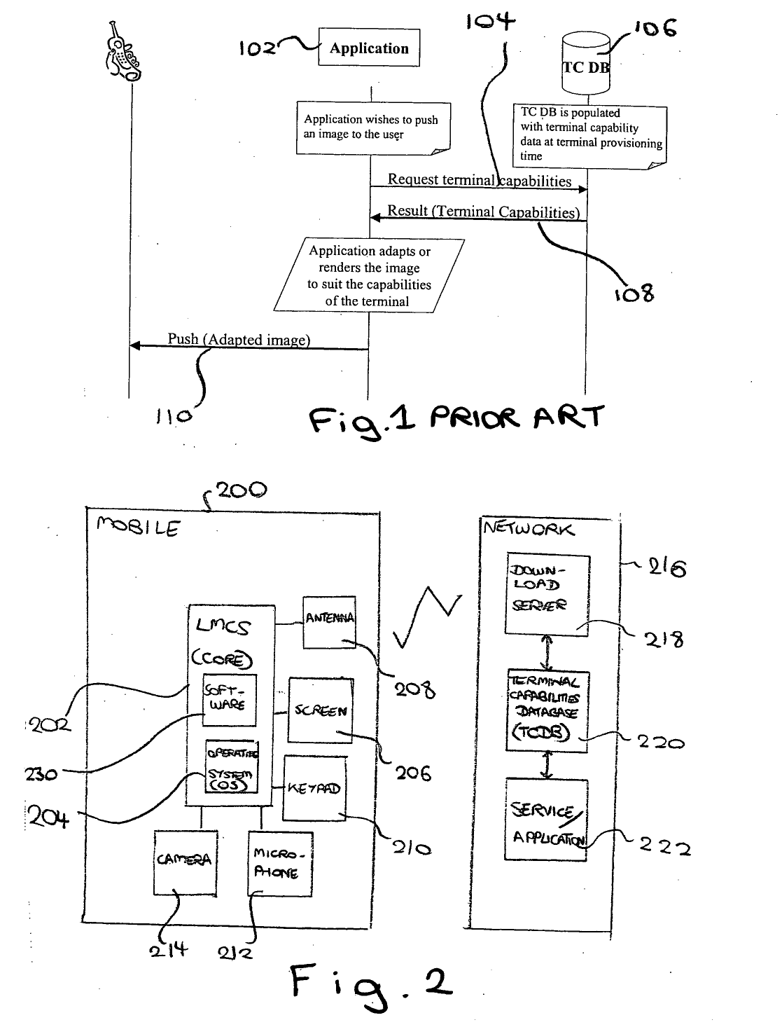

Before describing the embodiments in detail, we first describe a known system for ease of comparison. As shown in FIG. 1, an example of the known approach is where an application 102 in a network wants to send a digital image to a particular wireless terminal. The application 102 sends a request 104 to be told of the terminal's capabilities to the database 106 of that information known as a terminal capabilities database (“TCDB”). The terminal capabilities database 106 sends a reply 108 including that information. Based on that information such as e.g. that the terminal has a small size screen and a browser with monochrome display capabilities, the image is processed so as to reduce the amount of data involved, for example the resolution of the image is reduced and the colours are reduced. The processed image 110 is then send to the terminal.

The inventors realised that in the known system the terminal capabilities database was not updated if the terminal's capabilities changed, for example due to a software upgrade or replacement of a plug-in component of the terminal.

Example System

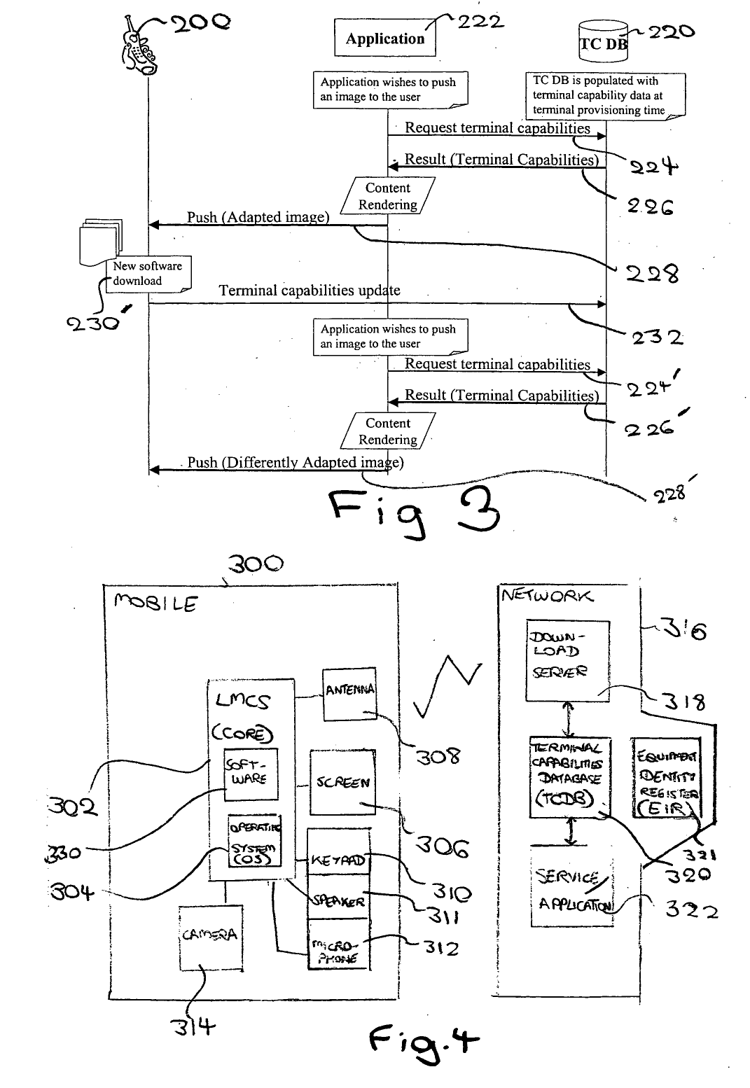

Turning now to an embodiment of the invention, as shown in FIG. 2, a mobile terminal 200 consists of a main processor 202 onto which an Operating System OS 204 has been loaded with appropriate software 230 for image display. The mobile terminal 200 includes a Liquid Crystal Display screen 206, a radio antenna 208, a keypad 210, a microphone 212 and a digital camera 214. The network 216 with which the terminal communicates by radio includes a download server 218, a terminal capabilities database TCDB 220, and an application 222.

The terminal capabilities database 220 records characteristics of terminals, such as screen size and memory available. This information is stored initially at the time that the terminal is configured and handed out to a user ready for use.

Referring now to FIG. 3, consider where the application 222 wants to send a digital image to the wireless terminal 200. The application 222 sends a request 224 to be told of the terminal's capabilities to the database 220. The terminal capabilities database 220 sends a reply 226 including that information. Based on that information such as e.g. that the terminal has a small size screen and a browser with monochrome display capabilities, the image is processed so as to reduce the amount of data involved, for example the resolution of the image is reduced and the colours are reduced. The processed image 228 is then sent to the terminal 200. Consider that the terminal 200 then receives a download of new software 230′ for image display such that its capabilities are improved or altered. This is noted by the core system 202, which controls the terminal to automatically send a terminal capabilities database update signal 232 to the network 216. This signal 232 is received in the network and directed to the terminal capabilities database TCDB 220 so as to update that database 220. Thereafter when the application 222 wants to send a further digital image it sends a request 224′ to be told of the terminal's capabilities to the database 220. The terminal capabilities database 220 sends a reply 226′ including that updated information. The image 228′ processed so as to take account of the terminal's new capabilities is then sent to the terminal 200.

In this example, the terminal 200 is BREW capable, and the image which user first sees on his terminal 200 is a postcard of such poor quality that the user chooses new software 230′ of browser software able to display 32-bit colour images. This is downloaded from the download server 218 of a BREW Distribution System (“BDS”). From inspection of the updated database 220 the application 222 sends an image of the postcard with the same resolution as previously, but this time in colour.

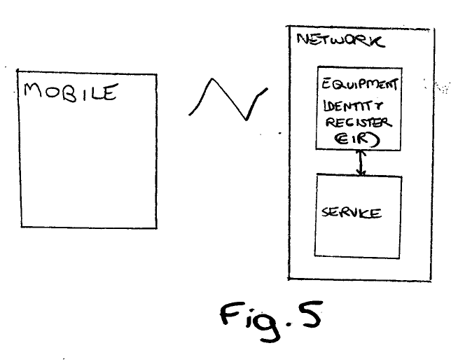

In a second example, a notional user called Alice buys a new wireless terminal 300 which is shown in FIG. 4. It includes a main processor 302, which hosts an operating system OS 304 and software 330. The can be provided to the terminal from a personal computer (not shown) or by radio from a download server 318 of a network 316. Since she wants to run video applications, she selected a high specification but compact screen 306 and plugs that into her terminal 300. She does not plan to do a lot of texting or keyboard work, so she installed a low specification keypad 310 with speaker 311 and microphone 312. She wants good peer-to peer video capability so included a top-of the range digital camera 314.

Before use, the network operator with which Alice has her contract for mobile telecommunications services stores, in a terminal capabilities database TCDB 320 parameter values describing the terminal's capabilities, in view of the screen, keypad, camera etc selected.

When Alice turns on her phone, the software 330 configures itself, for example by software-drivers for the particular components being downloaded by radio and the terminal 300 becoming ready for use. The terminal registers with the network by the main processor 302 causing an appropriate registration message to be sent from the terminal 300 to a further database 321, known as an Equipment Identity Register EIR, in the network 316.

Alice swaps various peripheral components of her terminal 300, such as the screen 306, camera 314, keypad 310 and antenna 308 “on the fly”—e.g., herself and practically immediately, in contrast to needing to send the terminal for upgrade by another). If she wants to send email, for example, she may simply pull off the low specification keypad and plug in a more sophisticated keypad, for example a 128-key folding keypad. She does not need to power down or stop a call connection with the network 316 during this change of keypad.

As the terminal's capabilities have changed, the network 316 is to be informed so that applications, such as application 322 shown in FIG. 4, can use any of the full range of the terminal's current capabilities in providing a user-friendly but efficient service to the user. Specifically, the main processor 302 of the terminal 300 sends a notification via the antenna 308 and by radio to the network 316. The notification is received and sent to the terminal capabilities database TCDB 320.

The terminal capabilities database TCDB 320 is similarly updated where upgrades to the software 330 running in the terminal 300 causes improvements or changes in the terminal's capabilities. Alice can download new software, such as a media player for example, to her terminal and execute that software in the course of accessing services. For example, Alice could download a H.264 coder-decoder program and use this to send more efficiently encoded media data streams in peer-to-peer video applications, e.g. to send video clips of her best friend's wedding to an aunt overseas. The terminal 300, in particular its main processor 302, causes an update notification to be sent to the network 316.

Software is downloaded from a download server 318 which monitors and charges the user for software downloads made. The terminal can be granted a limited license for use of the software, for example a limited number of uses or time period of use, after which the network 316 will not interact with that software. Some further options and variants In another embodiment, the terminal can be a J2ME (Java 2 Micro Edition) terminal that can download software from download servers known as Java Vending Machines (JSR-124). In another embodiment, the terminal can be a BREW (Binary Runtime for Wireless) terminal that can download software from a download server known as a Brew Distribution System (“BDS”).

The terminal capabilities database TCDB can, in some embodiments, send messages to interested parties, or applications subscribed to by the user, that the user's terminal capabilities, be they in terms of hardware, firmware or software, have changed.

In some embodiments, for example as shown in FIG. 5 where the mobile terminal is as shown in FIG. 2, rather than informing a terminal capabilities database TCDB, an Equipment Identity Register EIR performs the function of the terminal capabilities database. The EIR is a database of records of terminal equipment data.

General

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method of communicating with a wireless terminal comprising:
receiving an indication that capability of the terminal has changed due to at least one of a replacement or an upgrade of at least one component of the terminal;
updating a record in a database corresponding with the indication of change;
inspecting the database to offer a service adapted using the updated record; and
providing the adapted service.

2. A method according to claim 1, wherein the terminal is upgraded with a screen.

3. A method according to claim 1, wherein the service is adapted by sending more detailed images.

4. A method of receiving a service with a wireless terminal comprising:
at least one of replacing and upgrading at least one component of the wireless terminal to change the capability of the terminal;
sending a notification of the change in capability of the terminal; and
receiving the service adapted to the changed capability.

5. A method according to claim 4, wherein the component comprises software.

6. A method according to claim 5, wherein the terminal includes a computer operating system onto which the at least one of replacing and upgrading software is loaded.

7. A method according to claim 5, wherein the software is received by radio.

8. A method according to claim 4, wherein the component comprises hardware, and the at least one of replacing and upgrading of said hardware is performed by the user.

9. A method according to claim 8, wherein said hardware comprises at least one of a screen, a keyboard, and a digital camera.

10. A wireless telecommunications terminal configured to receive a telecommunications service, the terminal comprising:
a transmitter configured to send a notification of a change in capability of the terminal in response to a component of the terminal being at least one of replaced and upgraded;
a receiver configured to receive the telecommunications service adapted to the changed capability.

11. A wireless telecommunications terminal according to claim 10, wherein the component comprises software.

12. A wireless telecommunications terminal according to claim 11, wherein the terminal includes a computer operating system onto which the at least one of a replacement and upgrade software is loaded.

13. A wireless telecommunications terminal according to claim 11, wherein the software is received by radio.

14. A wireless telecommunications terminal according to claim 10, wherein the terminal is configured to receive and be updated with Binary Runtime for Wireless software.

15. A wireless telecommunications terminal according to claim 10, wherein the terminal is configured to receive and be updated with Java 2 Micro Edition software.

16. A wireless telecommunications terminal according to claim 10, wherein the terminal includes hardware components adapted for at least one of a replacement and upgrade by the user.

17. A wireless telecommunications terminal according to claim 16, wherein the hardware components comprises at least one of a screen, a keyboard, and a digital camera.
